(19) United States
(12) Patent Application Publication
(10) Pub. No.: US 2007/0172223 A1
(43) Pub. Date: Jul. 26, 2007

(54) ATTENTION-GETTING CAMERA ATTACHMENT

(76) Inventor: Edward Corey Eberhardt, Somerset, WI (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/275,667

(22) Filed: Jan. 23, 2006

(51) Int. Cl. G03B 17/18

(52) U.S. Cl. 396/281

(57) ABSTRACT

An attention-getting camera attachment connects to a standardized connector of a camera or tripod, such as to a tripod screw receptacle of a camera, a tripod screw of a tripod for a camera, or a universal serial bus (USB) or other connector of the camera for example. The attachment includes an ornament for garnering the attention of a subject being photographed. The ornament may incorporate light, color, sound, motion, chemical, odor, or other techniques for attracting attention. One or more attention-getting features may be actuated manually by the user, or automatically in response to an electrical, optical, or other signal from the camera. Various components of the attention-getting camera attachment may be packaged and sold together as a kit.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2003, Edward Corey Eberhardt, All Rights Reserved.

### TECHNICAL FIELD

This patent document pertains generally to still and moving image photography, and more particularly, but not by way of limitation, to an attention-getting camera attachment.

### BACKGROUND

Personal and professional photography, both still and moving video, continues to gain popularity. Often, the object of photography is on human subjects, including young children and pets. Attracting the attention of such subjects can be nearly impossible. The present inventor has recognized a need for improved systems, devices, and methods for attracting the attention of a subject being photographed.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates generally an example of portions of an attention getting camera attachment and an environment in which it may be used.

FIG. 2 illustrates generally various examples of connectors for mating with a standardized tripod screw receptacle of a camera or with a standardized tripod screw of a tripod.

FIG. 3A illustrates an example using light to attract a subject's attention.

FIG. 3B illustrates an example using sound to attract a subject's attention

FIG. 3C illustrates an example using motion to attract a subject's attention

FIG. 3D illustrates an example using stored electrical energy to power one or more devices that help draw a subject's attention toward an ornament.

FIG. 3E illustrates generally an example using actual or simulated food, chemical, or odor to attract a subject's attention.

FIG. 4A illustrates generally examples of using a photo-sensor or like actuator to actuate power to an ornament, such as for triggering one or more attention-getting features of the ornament, such as in response to a camera flash.

FIG. 4B illustrates generally examples of using a photo-sensor or like actuator to actuate power to an ornament, such as for triggering one or more attention-getting features of the ornament, such as in response to a non-flash energy source from a camera.

FIG. 4C illustrates generally an example of using a digital or analog electrical or other signal provided from the camera to actuate power to the ornament, such as for triggering one or more attention-getting features of the ornament.

FIG. 4D illustrates generally an example of using an electrical signal connector of the camera to attach to the camera an ornament or an assembly that includes the ornament.

FIG. 5A illustrates an example in which an ornament hangs or dangles down from a camera.

FIG. 5B illustrates an example in which an ornament is capable of being positioned above a camera.

FIG. 5C Illustrates an example in which an ornament is attached directly to a connector, such as without using an elongate member.

FIG. 6 is a flow chart illustrating generally one or more methods of using an attention-getting camera attachment.

FIG. 7 illustrates generally an example of a kit in which the attention getting camera attachment may be packaged or sold.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

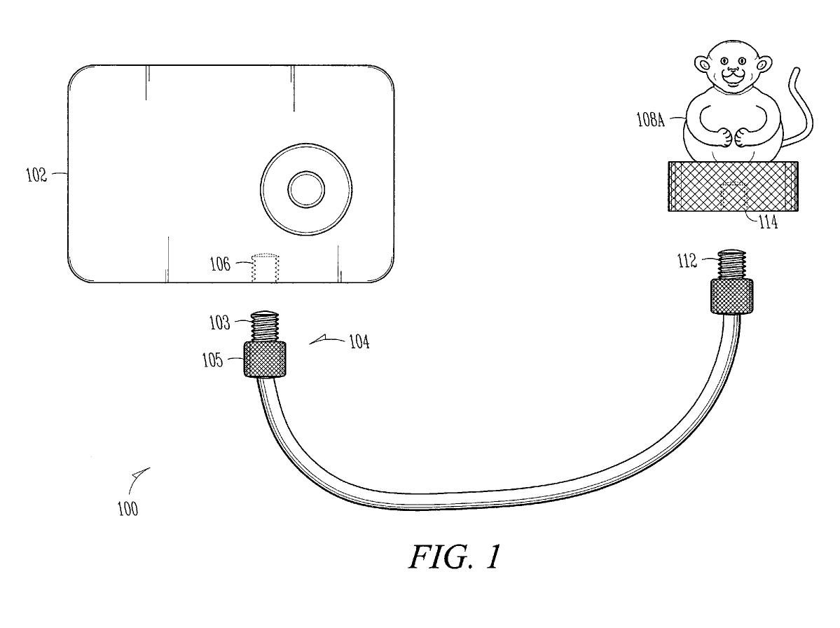

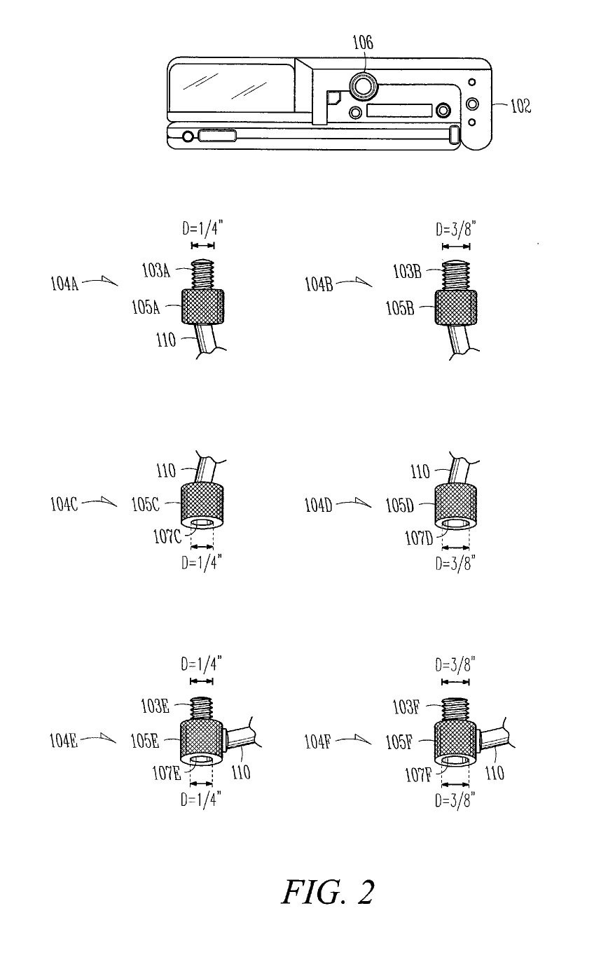

FIG. 1 illustrates generally an example of portions of an attention-getting camera attachment device 100 and an environment in which it is used, such as with a camera 102. In this example, the device 100 includes a male or female mating connector 104. In this example, the connector 104 includes a knurled gripping knob 105 and a threaded tip 103. In certain examples, the threaded distal tip 103 is sized and shaped to be threaded into engagement with a mating tripod screw receptacle 106 of the camera 102 or a mating tripod screw of a camera tripod, such as described below. In the example of FIG. 1, the connector 104 is illustratively shown as having a distal tip 103 that includes a blunt-tipped male threaded screw having a diameter of ¼ inch or ⅜ inch or other appropriate diameter to mate with a corresponding standardized tripod screw receptacle 106 in a commercially sold consumer or professional camera 102, such as shown in FIG. 2. Examples of standard cameras 102, standard camera screw receptacles 106, and standard tripod screws are readily available in the commercial market for consumer or professional photography equipment. The connectors 104 are not limited in any way by the dimensions herein described. The dimensions are only examples of possibilities, and are convenient for use with commercially available products.

In the example of FIG. 1, the connector 104 may alternatively be user-detachable from the elongate member 110, such that multiple different sized connectors 104 could be packaged together as a kit with the elongate member 110, such as to permit the device 110 to be used with both consumer and professional cameras having differently-sized standard tripod screw receptacles 106.

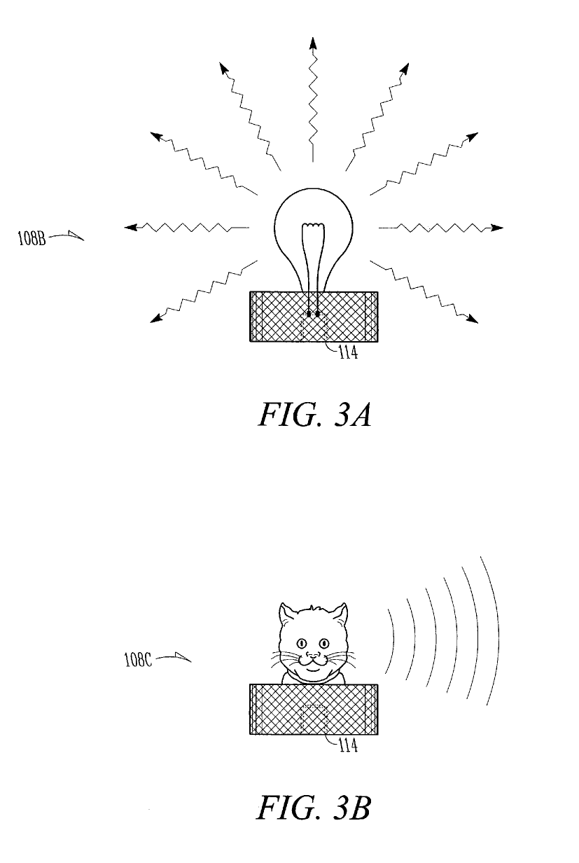

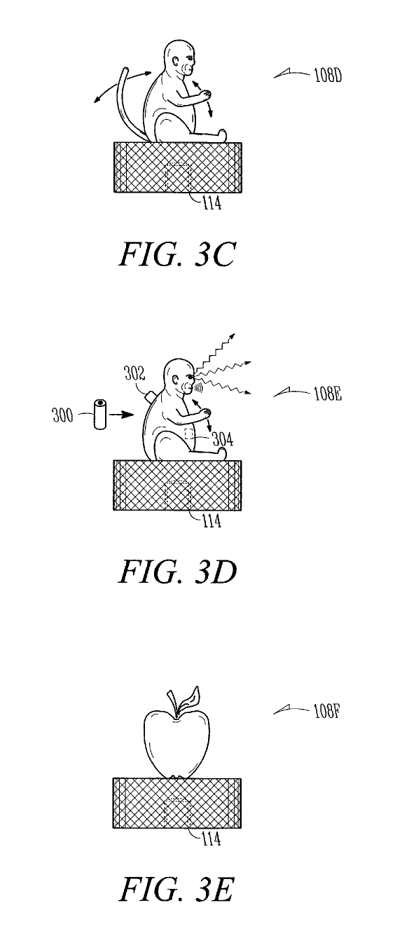

In the example of FIG. 1, an attention-getting ornament 108A is coupled to the connector 104, such as by a flexible or other elongate member 110. In certain examples the ornament 108A is removably coupled to the connector 104, such as by a suitable male or female connector 112 that engages a corresponding male or female receptacle 114 of the ornament 108A. While not required, this permits the user to attach or detach the ornament 108A such as by threading, snap-fitting, etc. Among other things, this permits selection between two or more different ornaments 108A-F (such as shown in FIGS. 3A-3F) by the user. The selected ornament 108A-D can then be attached by the user, such as where multiple ornaments 108 are packaged with an assembly of the connector 104 and the elongate member 110 in a kit for convenient use by the user. In an alternative example, the connector 112 and receptacle 114 are omitted, and the ornament 108A is permanently affixed to the elongate member 110.

In certain examples, the elongate member 110 includes a coiled wire arm or like structure, which typically provides both flexibility and shape-retention. This allows the location of the ornament 108 to be adjusted and held in place, such as while the connector 104 is engaged to the receptacle 106 of the camera 102, or even before such engagement is made, if desired. Because the ornament 108 is typically used to attract the attention of the subject being photographed, the elongate member 110 can be used to position the ornament 108 in a desired location with respect to the camera, so that the subject's attention can be attracted directly toward the lens of the camera 102, or to a separate location near the camera 102 but away from the lens, if desired.

In certain examples, the coiled wire arm includes a rubberized outer sheath over its plurality of coils. Other examples of the elongate member 110 need not include flexibility or shape-retention. In certain examples, the elongate member 110 includes a string, ribbon, or the like, which may permit the ornament 108 to swing freely with respect to the connector 104 and the camera 102 to which it is attached. In certain examples, elongate member 110 is omitted, for example, the ornament 108 may be permanently or removably directly attached to the connector 104, such as by using an adhesive, Velcro, a snap-fitting, or the like.

In certain examples, the ornament 108 is configured to attract the attention of a human or animal subject, such as a small child or pet, for example. The attention getting ornament 108 may be anything that attracts the attention of a subject. It is not limited in any way to the possibilities described here.

FIG. 2 illustrates generally various examples of connectors 104 for mating with a tripod screw receptacle 106 of a camera 102 or with a tripod screw of a tripod. Connector 104A includes a ¼ inch threaded tip 103A, such as for engaging a correspondingly sized receptacle 106 of a camera 102. Connector 104B includes a ¼ inch threaded tip 103B, such as for engaging a correspondingly sized receptacle 106 of a camera 102. Connector 104C includes a ¼ inch threaded receptacle 107C, such as for engaging a correspondingly sized tripod screw of a tripod. Connector 104D includes a ⅜ inch threaded receptacle 107D, such as for engaging a correspondingly sized tripod screw of a tripod. Connector 104E includes both a ¼ inch threaded tip 103E, for engaging a correspondingly sized receptacle 106 of a camera 102, and a ¼ inch threaded receptacle 107E, for engaging a correspondingly sized tripod screw of a tripod. In this example, the elongate member 110 extends outward from a cylindrical sidewall of the knurled knob 105E. Connector 104F includes both a ⅜ inch threaded tip 103E, for engaging a correspondingly sized receptacle 106 of a camera 102, and a ⅜ inch threaded receptacle 107E, for engaging a correspondingly sized tripod screw of a tripod. In this example, the elongate member 110 extends outward from a cylindrical sidewall of the knurled knob 105F.

FIG. 3A illustrates conceptually an example of an ornament 108 that uses light or bright color to help draw a subject's attention toward the ornament 108. For example, the ornament 108 may include one or more light-emitting diodes (LEDs) or light bulbs, and such lights may be incorporated into other design features. Examples of the use of light or color include, but are not limited to, a flashing light, projection of a kaleidoscope, use of a mirror, projecting an image on an electronic display medium such as a liquid crystal display (LCD) screen, or a photograph of a loved one, pet, etc. Use of light or color may be combined with one or more other techniques of attracting the subject's attention.

FIG. 3B illustrates conceptually an example of an ornament 108 that uses sound to help draw a subject's attention toward the ornament 108. Examples of the use of sound include, but are not limited to: music, a loved one or pet's voice, or an animal sound. Use of sound may be combined with one or more other techniques of attracting the subject's attention.

FIG. 3C illustrates conceptually an example of an ornament 108 that uses motion to help draw a subject's attention toward the ornament 108. Examples of the use of motion include, but are not limited to: an electric-powered movable object, a spring-loaded (e.g., bobblehead-like) or other mechanically movable object, etc. Use of motion may be combined with one or more other techniques of attracting the subject's attention.

FIG. 3D illustrates generally an example of an ornament 108 that uses stored electrical energy to power one or more devices that help draw a subject's attention toward the ornament 108. In this example, the ornament 108 is configured in an animal or other interesting shape (e.g., monkey, lion, clown, etc.), such as to draw the attention of a child or other human subject. In certain examples, the ornament 108 includes an electrical power source, such as a battery 300. The battery 300 is typically inserted into and housed by the ornament 108. The battery 300 may be replaceable or rechargeable. In the example of FIG. 3D, the animal-shaped housing of the ornament 108 also includes an actuator, such as a user-manipulable power switch 302, such as to control electrical power delivery to a control circuit 304 housed within the ornament 108. Various types of switches 302 can be used and, in certain examples, the actuator is motion-activated, such that tapping or jiggling of the ornament 108 triggers one or more responsive attention-getting features. A multi-state (e.g., tri-state) switch 302 or multiple switches 302 can also be used to provide the desired functionality. For example, a first switch 302 could be used to trigger one or more responsive attention-getting features and a second switch 302 could be used to inhibit an audible attention-getting output, such as where the device 100 is to be used with a videocamera that also records sounds. Alternatively, a tri-state switch 302 could be used, such as to separately actuate visual and audible attention-getting features, so that the audible attention-getting features can be inhibited during any sound recording by a videocamera, if desired. Moreover, the switch 302 need not be located on the ornament 108, but could instead be located elsewhere and electrically coupled to the control circuit 304, which can also be housed within the ornament 108 or elsewhere. As an illustrative example, the switch 302 could be located over or near to a shutter or filming activation button of the camera 102, to allow convenient manipulation by the user. In an example in which a touch-sensitive switch 302 is placed over the shutter activation button of the camera 102, this permits actuation of one or more attention-getting features when the shutter activation button is partially depressed by the user (e.g., to activate an autofocus) or fully depressed by the user.

The control circuit 304 controls actuation one or more electrically-powered attention getting facets of the ornament 108. As an illustrative example, actuating the switch 302 causes LED “eyes” of the animal-shaped housing to blink on/off, such as either continuously or at periodic or occasional intervals, causes an animal-shaped housing of the ornament 108 to “wag its tail,” “wiggle its ears,” etc., or causes the ornament 108 to emit one or more animal sounds, or to perform a combination of two or more similar attention-getting techniques.

FIG. 3E illustrates generally an example of an ornament 108 using actual or simulated food, chemical, or odor to attract a subject's attention. Examples include but are not limited to: candy to attract children, meat or dog biscuits to attract dogs, catnip or cat treats to attract cats, one or more mating scents or pheromones to attract the attention of any responsive human or animal. Use of food, chemical, or odor may be combined with one or more other techniques of attracting the subject's attention.

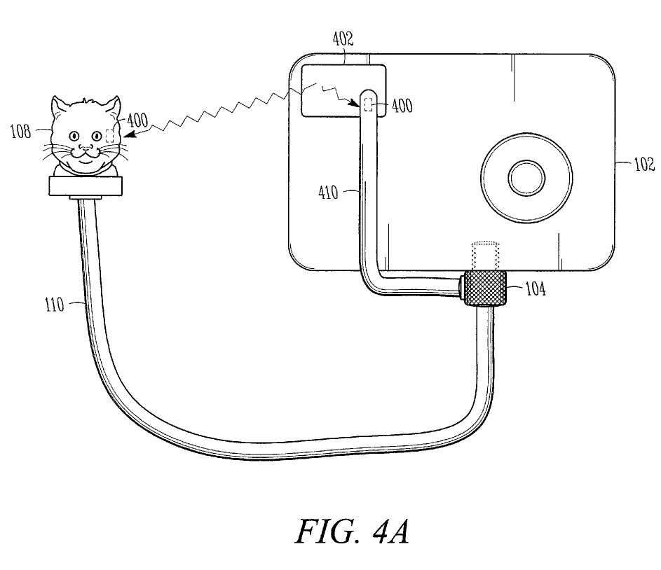

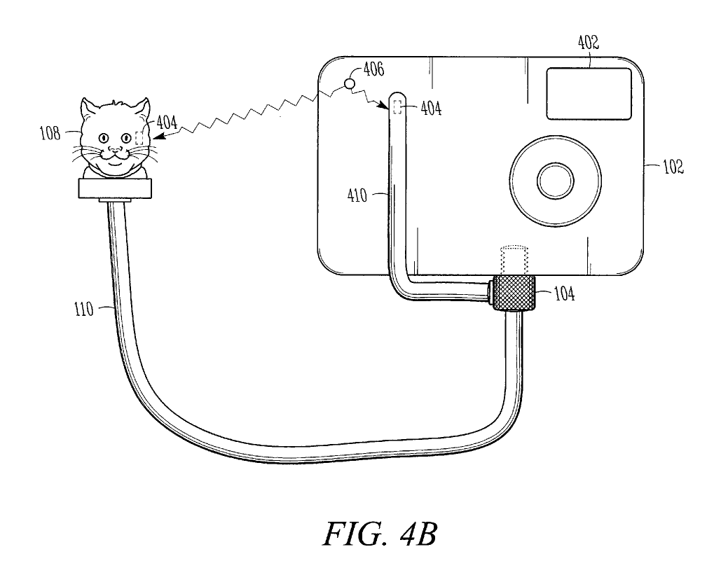

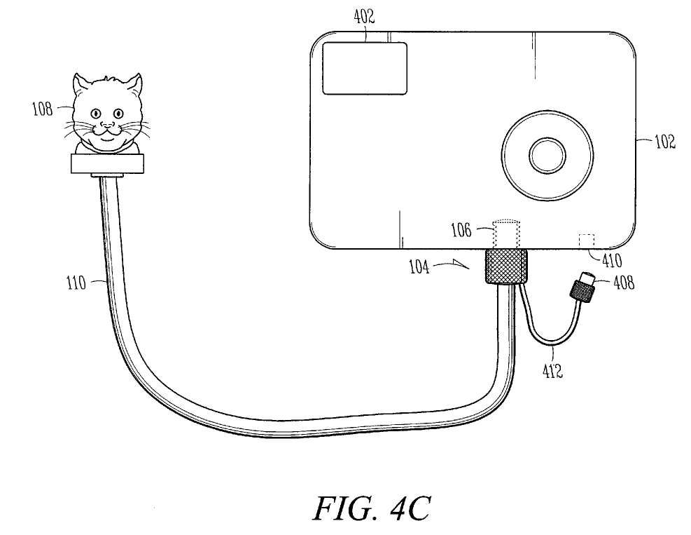

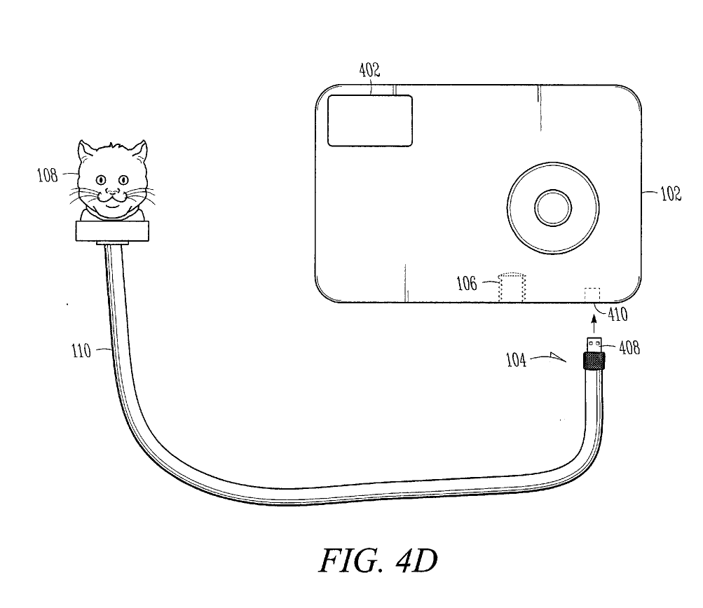

FIG. 4A illustrates generally examples of using a photo-sensor or like actuator 400 to actuate power to the ornament 108, such as for triggering one or more attention-getting features of the ornament 108, such as described above. In certain examples, the actuator 400 is positioned to receive light from a camera flash 402. The actuator 400 is typically electrically connected to the control circuit 304. When a camera flash is detected by the actuator 400, it communicates such information to the control circuit 304, which, in turn, activates one or more attention-getting features of the ornament 108, such as one or more blinking lights, one or more sounds, one or more moving components, or the like. In certain examples, the actuator 400 is located on a backside or elsewhere of the housing of the ornament 108. In certain other examples, the actuator 400 is located separately from the ornament 108, such as at a distal end of a separate elongate member arm 410, or affixed to the camera flash (integral to the camera or separate) itself. In such examples, the actuator 400 need only be capable of detecting light from the flash and coupling a responsive signal to the control circuit 304.

FIG. 4B illustrates generally an example of using of an energy sensor such as a photo-sensor or like actuator 404 to actuate power to the ornament 108, such as for triggering one or more attention-getting features of the ornament 108, such as described above. In certain examples, the actuator 404 is positioned to receive light from an LED 406 or other non-flash light source located on the camera 102. In certain examples, the LED is actuated in response to the photographer depressing a shutter-activating button completely or partially. For example, certain cameras 102 use an active autofocus (AF) system that emits an infrared light and adjusts focus using light reflected back from the subject. Other active AF systems emit ultrasound for autofocusing, in which case the energy sensor can include a sound detector for performing the actuation. In other examples, the camera 102 includes a non-flash light source such as an LED that is actuated in response to a timer included within the camera 102. The actuator 404 is typically electrically connected to the control circuit 304. When light from the LED 406 is detected by the actuator 404, it communicates such information to the control circuit 304, which, in turn, activates one or more attention-getting features of the ornament 108, such as one or more blinking lights, one or more sounds, one or more moving components, or the like. In certain examples, the actuator 404 is located on the housing of the ornament 108. In certain other examples, the actuator 404 is located separately from the ornament 108, such as at a distal end of a separate elongate member arm, or affixed to the camera 102 itself. In such examples, the actuator 404 need only be capable of detecting light from the LED 406 or other non-flash light source such as may be provided by the camera 102.

FIG. 4C illustrates generally an example of using a digital or analog electrical or other signal provided from the camera 102 to actuate power to actuate power to the ornament 108, such as for triggering one or more attention-getting features of the ornament 108, such as described above. In certain examples, a universal serial bus (USB) or other electrical connector 408 is used to connect to a mating USB or other connector 410 of the camera 102, such as to receive such an actuation signal. A digital USB output connector 410 is provided as a standard feature of many commercially available cameras 102. The digital or analog actuation signal is not limited to a signal using a USB signal communication protocol, but could use any other method for transmitting or receiving data.

The connector 408 is typically connected to the electronic control circuit 304 of the ornament 108, such as by using a wire 412, having one or more conductors, either alone or in combination with one or more conductive elements included in the elongate member 110. In certain examples, this includes making an electrical connection to a hub 412 portion of the connector 104, with wiring extending through the elongate member 110, if any, to the control circuit 304 of the ornament 108. If the USB connector 408 (or other electrical signal connector) is appropriately located upon the bottom, side or elsewhere on the camera 102 and provides enough stability, it can be used instead of the threaded tip of the connector 104 to provide stable affixation of the ornament 108 to the camera 102, such as illustrated in the example shown in FIG. 4D.

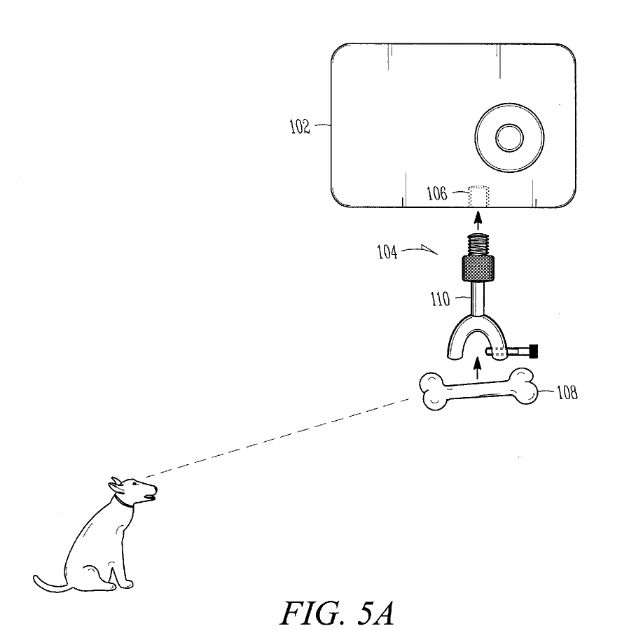

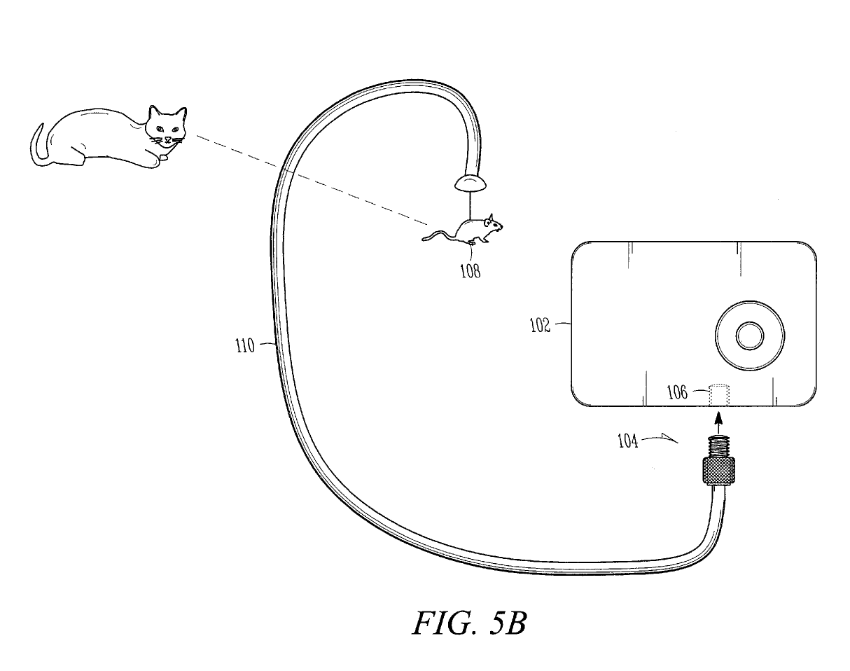

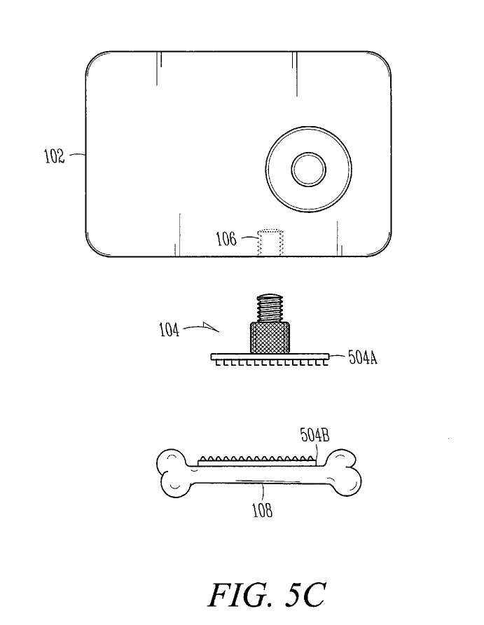

FIG. 5A illustrates an example in which the ornament 108 hangs or dangles down from the camera 102. In certain examples, the elongate member 110 includes a somewhat flexible string or wire, which may permit the ornament 108 to swing or sway, such as in a back-and-forth motion, for example. This may be useful for placing the attractive ornament 108 within reach of the subject, such as to capture one or more images of the subject interacting (e.g., reaching toward) the ornament 108. An illustrative example is illustrated in FIG. 5A, in which the subject is a dog looking or reaching toward a bone or bone-shaped ornament 108. In certain examples, the bone or other ornament 108 is attachable or detachable by the photographer. In certain examples, the bone or other ornament 108 is attachable or detachable by the subject (e.g., the dog).

FIG. 5B illustrates an example in which the ornament 108 is capable of being positioned above the camera 102. In certain examples, the elongate member includes a somewhat flexible string or wire 502, which may permit the ornament 108 to swing or sway, such as in a back-and-forth motion, for example. Such a wire 502 may include one or more electrical conductors, such as for communicating an actuation signal with the ornament 108. In the example of FIG. 5B, the string or wire 502 is shown as being coupled to one end of a flexible but shape-holding portion of the elongate member 110, the other end of which, in turn, is coupled to the connector 104. This may be useful for placing the attractive ornament 108 at a desired position with respect to the subject, such as to capture one or more images of the subject interacting (e.g., reaching toward) the ornament 108. An illustrative example is illustrated in FIG. 5B, in which the subject is a cat looking or reaching upward toward a mouse-shaped ornament 108, instead of looking directly toward the camera lens. In certain examples, the ornament 108 is attachable or detachable by the photographer. In certain examples, the bone or other ornament 108 is attachable or detachable by the subject (e.g., the cat).

FIG. 5C Illustrates an example in which the ornament 108 is attached directly to the connector 104, such as without using an elongate member 110. In the example of FIG. 5C, the connector 104 includes a fastener 504 or adhesive. In the example of FIG. 5C, the fastener 504A includes a hooked or looped surface (e.g., Velcro) for attaching to a respective looped or hooked surface 504B on the ornament 108. As described above, the connector 104 can be conveniently threaded into a mating standard-sized tripod screw receptacle 106 of the camera 102. This example will typically attract the attention of the subject directly toward the camera 102, rather than to a more distant location as might be the case in which an elongate member 110 is used. This also permits the connector 104 to be used with a toy or object that the subject is already familiar with, such as by simply applying an appropriate adhesive or fastener to that existing toy or object so that it can be coupled to the connector 104, which, in turn, can be securely connected to the receptacle 106.

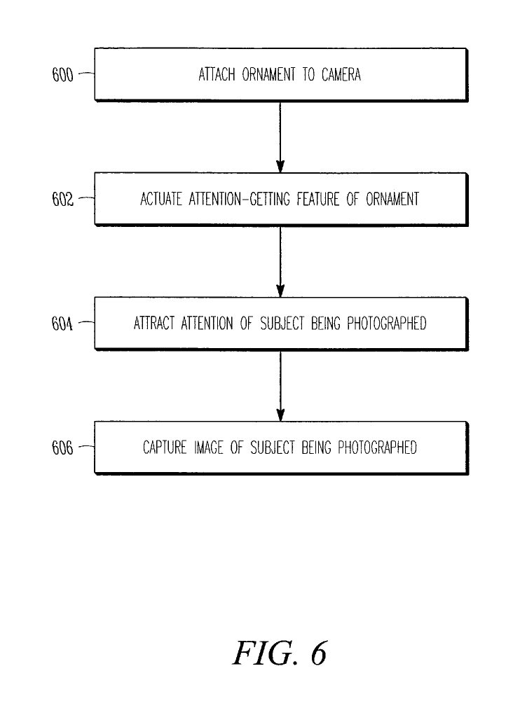

FIG. 6 is a flow chart illustrating generally one or more methods of using an attention-getting camera attachment. In this example, at 600, an ornament 108 is attached to a still or moving-image camera 102. At 602, one or more attention-getting features (e.g., light, sound, movement, etc.) of the ornament 108 is optionally actuated, such as described above. This may include manual actuation by the user, or automatic actuation (e.g., via a trigger signal from the camera 102), such as described above. Alternatively, the appearance or configuration of the ornament 108 is itself enough to provide attention-getting feature without requiring any such actuation. For example, the ornament 108 may include a “bobblehead-like” mount that ordinarily places in motion the ornament 108 or a portion thereof. In another example, the appearance of the ornament 108 is sufficiently attention-getting, without more. At 604, the attention getting ornament 108 is used to attract the attention of the subject being photographed. At 606, a still or moving image of the attracted subject is captured.

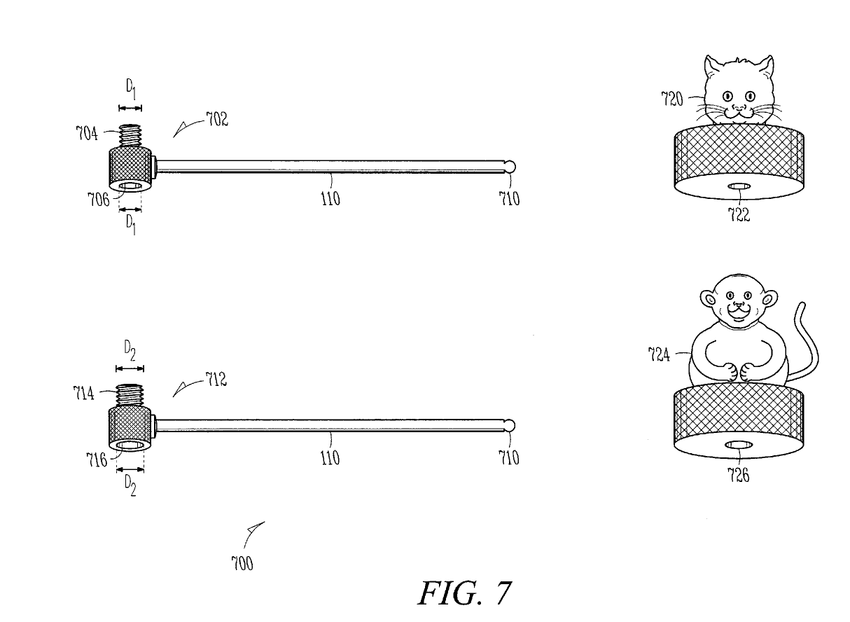

FIG. 7 illustrates generally an example of a kit 700 in which the attention getting camera attachment may be packaged and sold. In this example, the kit 700 includes a first connector 702 including a first diameter (e.g., ¼ inch) threaded tip 704, for engaging a corresponding standardized tripod screw receptacle 106 of a camera 102, and a first diameter (e.g., ¼ inch) threaded receptacle 706, for engaging a corresponding standardized tripod screw of a tripod for a camera 102. In this example, the connector 702 is attached to a flexible elongate member 110 having a distal male or female snap-fitting 710.

In this example, the kit 700 also includes a second connector 712 including a second diameter (e.g., ⅜ inch) threaded tip 714, for engaging a corresponding standardized tripod screw receptacle 106 of a camera 102, and a second diameter (e.g., ¼ inch) threaded receptacle 716, for engaging a corresponding standardized tripod screw of a tripod for a camera 102. In this example, the connector 712 is attached to a flexible elongate member 110 having a distal male or female snap-fitting 710.

In this example, the kit 700 also includes a first ornament 720, with a male or female receptacle 722 that is couplable to the connectors 702 and 712, such as by engaging the desired snap-fitting 710. In this example, the kit 700 also includes a second ornament 724, with a male or female receptacle 726 that is couplable to the connectors 702 and 712, such as by engaging the desired snap-fitting 710.

The kit 700 of FIG. 7 advantageously provides multiple different ornaments and allows connection to multiple different standardized threaded connectors of cameras or tripods. However, the kit 700 of FIG. 7 is provided as an illustrative example. Various other components shown or described herein may, in various permutations and combinations, be advantageously packaged into a kit 700 that will be useful to different photographers having different needs.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

1. An apparatus including:
a male or female mating connector that is sized and shaped to engage a mating standardized female or male receptacle of a camera or a camera tripod; and
an attention-getting ornament, coupled to the connector by an elongate member that is flexible enough to permit a user to alter a position of the ornament with respect to a position of the connector, wherein the flexible elongate member includes a shape-retention to hold the ornament at the position to which the user has altered the ornament.

2. The apparatus of claim 1, in which the connector is threaded.

3. The apparatus of claim 1, in which the connector includes a standardized electrical signal connector.

4. The apparatus of claim 1, in which the connector includes either a ¼ inch diameter screw or receptacle or a ⅜ inch diameter screw or receptacle.

5. The apparatus of claim 1, in which the connector includes:
a knurled knob; and
an externally threaded screw, coupled to the knob.

6. (canceled)

7. (canceled)

8. The apparatus of claim 1, in which the ornament includes an attention-getting light.

9. The apparatus of claim 1, in which the ornament includes a speaker to produce an attention-getting sound.

10. The apparatus of claim 1, in which the ornament includes an attention-getting movable component.

11. The apparatus of claim 1, in which at least a portion of the ornament includes an attention-getting odor.

12. The apparatus of claim 1, in which at least a portion of the ornament includes a real or a simulated food.

13. The apparatus of claim 1, comprising a power source, operatively coupled to the ornament.

14. The apparatus of claim 1, comprising an actuator, operatively coupled to the ornament.

15. The apparatus of claim 14, in which the actuator is responsive to user-manipulation.

16. The apparatus of claim 14, in which the actuator is responsive to a signal received from the camera or a camera flash.

17. The apparatus of claim 16, in which the actuator is responsive to an non-camera flash light emitted from the camera.

18. The apparatus of claim 1, including a user-operable coupling between the ornament and the connector to permit the user to attach or detach the ornament from the connector.

19. A kit including:
a male or female mating connector that is sized and shaped to engage a mating standardized female or male receptacle of a camera or a camera tripod;
one or more attention-getting ornaments that are user-attachable to, and user-detachable from, the connector; and
an elongate member that is flexible enough to permit a user to alter a position of the ornament with respect to a position of the connector, wherein the flexible elongate member includes a shape-retention to hold the ornament at the position to which the user has altered the ornament.

20. The kit of claim 19, in which the connector is threaded.

21. The apparatus of claim 19, in which the connector includes a universal serial bus (USB) connector.

22. An apparatus including:
a male or female mating connector that is sized and shaped to engage a mating receptacle of a camera or a camera tripod;
means, coupled to the connector, for attracting attention of a human or animal subject and
an elongate member that is flexible enough to permit a user to alter a position of the ornament with respect to a position of the connector, wherein the flexible elongate member includes a shape-retention to hold the ornament at the position to which the user has altered the ornament.

23. The apparatus of claim 22, comprising:
an elongate member, coupling the means for attracting attention to the connector, the elongate member being flexible enough to permit a user to alter and hold a position of the ornament with respect to a position of the connector;
the connector including:
a knob; and
an externally threaded screw, coupled to the knob; the means for attracting attention including:
an attention-getting light;
a speaker to produce an attention-getting sound;
an attention-getting moving component;
a power source; and
an actuator.

24. A method including:
attaching an attention-getting ornament to a still or moving-image camera or to a tripod using a mating standardized receptacle of the camera or of a camera tripod;
adjusting a position of the ornament with respect to a position of the connector, the adjusting including using an elongate member that is flexible enough to permit a user to alter a position of the ornament with respect to a position of the connector, wherein the flexible elongate member includes a shape-retention to hold the ornament at the position to which the user has altered the ornament; and
using the ornament to attract attention of a subject being photographed.

25. The method of claim 24, in which the attaching includes threading into engagement.

26. The method of claim 24, in which the attaching includes plugging into a standardized electrical connector.

27. The method of claim 24, including actuating at least one of a light, sound, or motion component of the ornament.

28. The method of claim 27, in which the actuating includes actuating in response to a user manipulation of a switch.

29. The method of claim 27, in which the actuating includes actuating in response to a trigger signal received from the camera.
